(19) United States
(12) Patent Application Publication
(10) Pub. No.: US 2018/0186477 A1
(43) Pub. Date: Jul. 5, 2018

(54) SPACE SYSTEM

(71) Applicant: THALES, Courbevoie (FR)

(72) Inventors: Hervé SAINCT, Le Cannet (FR); Judith COTE, Toulouse (FR)

(21) Appl. No.: 15/855,697

(22) Filed: Dec. 27, 2017

(30) Foreign Application Priority Data
Jan. 5, 2017 (FR) 1700008

(51) Int. Cl. B64G 1/24

(52) U.S. Cl. CPC B64G 1/242; B64G 1/1021

(57) ABSTRACT

A space system comprises two main satellites each describing a distinct elliptical orbit around the Earth, each of the two orbits being such that the space system makes it possible to provide a permanent or continuous service over at most a terrestrial zone comprising a polar cap and a region of different latitude over an interval of longitudes.

### CROSS-REFERENCE TO RELATED APPLICATIONS

This application claims priority to foreign French patent application No. FR 1700008, filed on Jan. 5, 2017, the disclosure of which is incorporated by reference in its entirety.

### FIELD OF THE INVENTION

The invention relates to the field of space systems, and more particularly to the space systems with permanent coverage of a determined surface of the Earth.

### BACKGROUND

Geostationary and polar observation systems that are entirely separate, i.e. that have separate orbits and distinct ground observation zones, are well known.

The geostationary systems are perfectly well known, as are the polar systems, the latter in particular by the orbits used, whose classic names are known, such as the Molniya orbits or the Tundra orbits.

Also known are other orbits distinct from the two geostationary and polar types, as cited in the international patent application WO 2012/040828 A1, but which concern only the zones of latitudes above 60°, or the purely polar systems such as the so-called Three Apogee orbits, known by the acronym TAP, described in “Three-Apogee 16-h Highly Elliptical Orbit as Optimal Choice for Continuous Meteorological Imaging of Polar Regions”, by Trischenko & al, Journal of the American Meteorological Society, November 2011.

There is also the document FR 2291299 A1 which describes a space system comprising at least one satellite describing a retrograde heliosynchronous elliptical orbit around the Earth.

All these space systems have a very high cost, which is demonstrated by the fact that no single country has to date been able, on its own, to deploy a specific system on such orbits with permanent coverage, for example a meteorological system, as in Canada where the PCW project has been on hold for 10 years for want of budget.

### SUMMARY OF THE INVENTION

One aim of the invention is to be able to limit the cost of a continuous service, and to be able to share it over a region corresponding to several countries.

Another aim of the invention is to maintain a maximum degree of compatibility with the existing elements, both for the hardware of the satellites and embedded and instruments (to benefit from the recurrence or saving due to mass production and to the re-use of hardware already validated for the space environment) and for the launches (the recommended orbit should be compatible with the current launch vehicles and in particular the least expensive/powerful among them; an orbit that is inaccessible to the latter would be useless).

There is proposed, according to one aspect of the invention, a space system comprising
two main satellites each describing a distinct elliptical orbit around the Earth, each of the two orbits verifying the following characteristics:
the inclination of the plane of the orbit in relation to the equatorial plane lies between 55° and 65°,
the eccentricity of the orbit lies between 0.2 and 0.3,
the major half-axis of the orbit is set so as to obtain a geosynchronous orbit,
the argument of the perigee lies between 240° and 265° or between 275° and 300° for the coverage of a zone of latitude above at least 55° (North Pole cap) combined with an additional zone of latitudes below at most 55° and of longitudes lying within an interval of values having a length below a first threshold; or lies between 60° and 85° or between 95° and 120° for the coverage of a zone of latitude below at most −55° (South Pole cap) combined with an additional zone of latitudes above at least −55° and of longitudes lying within an interval of values having a length below a second threshold,
the longitude of the ascending node is defined as a function of the additional zone, such that it lies within an interval of values centred on the average longitude of the additional zone and having a length less than 80°, and
the two main satellites having a right ascension difference of the ascending node of 180° and with a true anomaly difference of 180°; and

at least one earth station configured to exchange data with at least one of said main satellites.

Such a space system makes it possible to provide a permanent or continuous service over at most a terrestrial zone comprising a polar cap as well as a region of different latitude over an interval of longitudes that can correspond to several countries wanting to share the costs of such a service, such as a meteorological or geolocation service, a telecommunication service of any kind (TV transmissions, internet access, radio, telephony, etc.), or an imaging service of any kind (for observation, detection/warning, tracking short and long term trends, etc.).

In one embodiment, the first threshold is 90° when the additional zone has a minimum latitude lying between 10° and 30°.

Thus, the permanent coverage obtained, in addition to the North Pole cap, makes it possible to serve one or more additional countries located up to a latitude that is very low in positive value terms, and is quasi-equatorial.

According to one embodiment, the first threshold is 150° when the additional zone has a minimum latitude lying between 30° and 50°.

Thus, a wide coverage, of continental dimension (or greater than a single country) is obtained in the northern hemisphere in addition to the North Pole cap. This makes it possible to provide a continuous service both to the northern countries and to a continent such as Europe or the Middle East for example.

In one embodiment, the second threshold is 90° when the additional zone (2) has a minimum latitude lying between −30° and −10°.

Thus, the permanent coverage obtained, in addition to the South Pole cap, makes it possible to serve one or more additional countries located up to a latitude that is very high in negative value terms, and is quasi-equatorial.

According to one embodiment, the second threshold is 150° when the additional zone (2) has a minimum latitude lying between 50° and −30°.

Thus, a wide coverage, of continental dimension (or greater than a single country) is obtained in the southern hemisphere in addition to the South Pole cap. This makes it possible to provide a continuous service both to users located in the polar region and to a continent such as Australia for example.

In one embodiment, the inclination of the plane of the orbit in relation to the equatorial plane lies between 60° and 65°.

Thus, the inclination can be chosen to accurately adjust the permanent coverage zone, while remaining close to the resonant orbits in relation to the Earth and sun/moon pull interactions: this closeness allows for a significant station-keeping fuel saving during the life of the satellites, and the adjustment makes it possible to further improve the coverage zone if necessary. Furthermore, this inclination allows for a good trade-off between the coverage of the polar zones, favoured by a high inclination, and that of the low-latitude zones favoured by a low inclination.

According to one embodiment, the inclination of the plane of the orbit in relation to the equatorial plane is 63.5°.

Thus, this value is precisely that of the resonant orbit previously described enabling the maximum fuel saving for station-keeping (or even, the longest mission duration for satellites provided with a fixed quantity of fuel).

In one embodiment, the eccentricity of the orbit is 0.25.

Thus, this eccentricity makes it possible to obtain the desired form for the permanent coverage on the ground while observing the criterion of launchability, that is to say that the orbit obtained is accessible via a given existing launch vehicle complemented by the specific delta-V means embedded in the satellite. Depending on the available capacity for the launch vehicles at the time of the contract and the desired form for the permanent coverage, this eccentricity parameter can vary.

According to one embodiment, the argument of the perigee lies between 280° and 290° for the coverage of a zone of latitude above 55° (North Pole cap) combined with an additional zone of latitudes below 55° and of longitudes lying within an interval of values having a length below the first threshold.

Thus, the permanent coverage zone obtained by the satellite system prioritizes the North Pole cap, but it also includes a territory located lower down towards the low latitudes covering a wide zone of longitudes.

In one embodiment, the argument of the perigee lies between 275° and 285° for the coverage of a zone of latitude above 55° (North Pole cap) combined with an additional zone of latitudes below 55° and of longitudes lying within an interval of values having a length below the first threshold.

Thus, the permanent coverage zone obtained by the satellite system comprises a territory located higher in terms of latitudes than in the preceding case while covering a wider zone of longitudes therein.

According to one embodiment, the argument of the perigee lies between 280° and 300°, for the coverage of a zone of latitude above 55° (North Pole cap) combined with an additional zone of latitudes below 55° and of longitudes lying within an interval of values having a length below the first threshold.

Thus, the permanent coverage zone obtained by the satellite system comprises a territory situated lower in terms of latitudes than in the preceding case while covering a narrower zone of longitudes therein.

In one embodiment, the system comprises at least one additional satellite as redundant standby for a main satellite, placed on the orbit of the corresponding main satellite, with an anomaly offset between the additional satellite and the corresponding main satellite.

Thus, the reliability of the system and the operational availability of the service are improved, the in-flight redundancy guaranteeing the absence of interruption of the service even in the case of complete failure of one of the satellites.

According to one embodiment, the system comprises at least one additional satellite placed on an elliptical orbit around the Earth, distinct from the two orbits of the two main satellites but verifying said same characteristics, the deviation between two satellites of the system being such that their right ascension deviation of the ascending node and their true anomaly deviation are 360° divided by the number of main satellites of the orbital system.

Thus, the permanent coverage zone can be enlarged. Likewise, a second pair of satellites can be installed at the same time or later, to obtain a wide extension of the permanent coverage.

### BRIEF DESCRIPTION OF THE DRAWINGS

The invention will be better understood on studying a number of embodiments described as nonlimiting examples and illustrated by the attached drawings in which:

FIG. 1 schematically illustrates a permanent coverage of the North Pole cap for a service, according to the prior art;

FIG. 2 schematically illustrates an additional zone contiguous to the North Pole cap of FIG. 1, according to one aspect of the invention;

FIG. 3 schematically illustrates a zone comprising the combination of the North Pole cap of FIG. 1 and the additional zone of FIG. 2;

FIGS. 4 and 5 schematically illustrate the orbits according to one aspect of the invention;

FIG. 6 represents the same plot on the ground of the satellites, as well as their respective iso-elevation curves possible at a given instant, according to one aspect of the invention; and

FIG. 7 represents, by way of illustration, the terrestrial regions permanently covered by at least one of the satellites with a minimum elevation chosen to be 27°, according to one aspect of the invention.

In the different figures, the elements that have identical references are identical.

### DETAILED DESCRIPTION

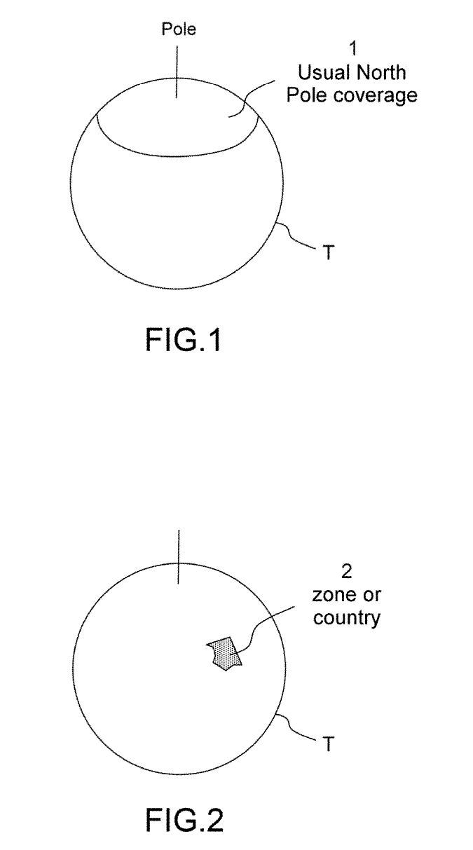

FIG. 1 schematically illustrates a permanent coverage of the North Pole cap 1 for a service, for example by a traditional system embedded on orbits of i=90°, or Molniya or Tundra, type, and concerned only with the polar service.

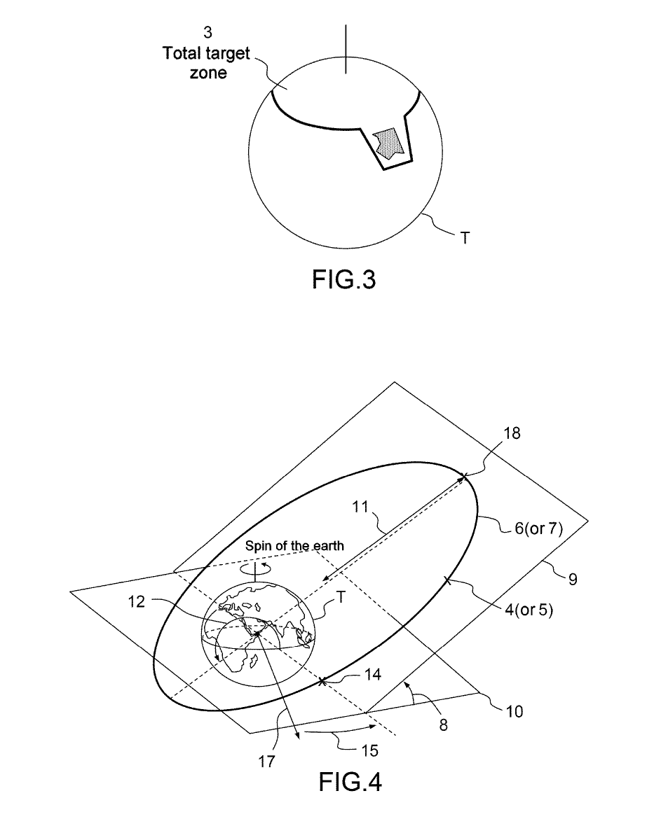

FIG. 2 schematically illustrates an additional zone 2 contiguous to the North Pole cap of FIG. 1, and FIG. 3 schematically illustrates a zone 3 comprising the combination of the North Pole cap of FIG. 1 and the additional zone of FIG. 2.

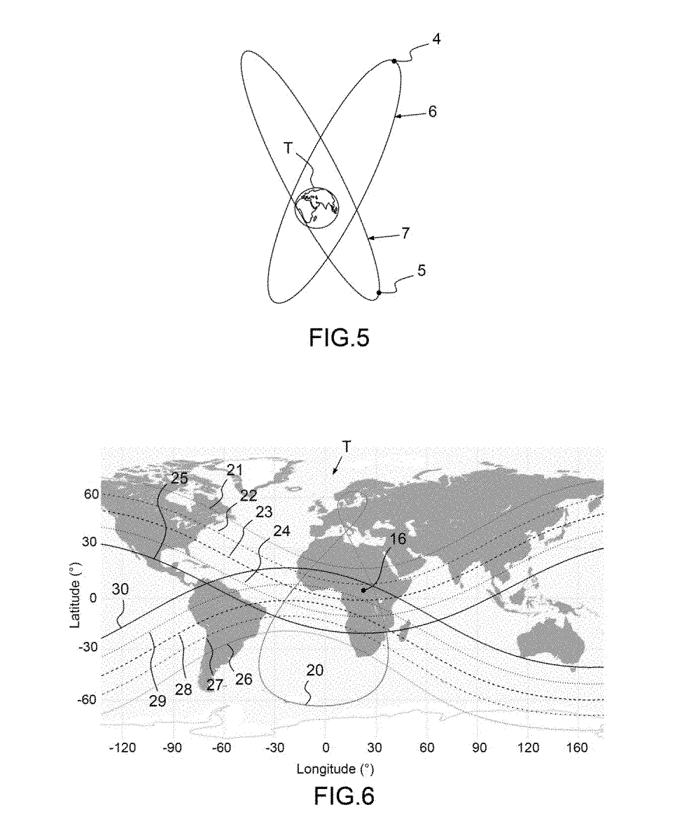

There is proposed, as illustrated in FIGS. 4 and 5, in a nonlimiting manner, a space system comprising

two main satellites 4, 5 each describing a distinct elliptical orbit 6, 7 around the Earth T, each of the two orbits 6, 7 verifying the following characteristics:
the inclination 8 of the plane 9 of the orbit 6, 7 in relation to the equatorial plane 10 lies between 55° and 65°,
the eccentricity of the orbit 6, 7 lies between 0.2 and 0.3,
the major half-axis 11 of the orbit 6, 7 is set so as to obtain a geosynchronous orbit 6, 7,
the argument 12 of the perigee 13 lies between 240° and 265° or between 275° and 300° for the coverage 3 of a zone 1 of latitude above 55° combined with an additional zone 2 of latitudes below 55° and of longitudes lying within an interval of values having a length below a first threshold; or lies between 60° and 85° or between 95° and 120° for the coverage 3 of a zone 1 of latitude below −55° combined with an additional zone 2 of latitudes above −55° and of longitudes lying within an interval of values having a length below a second threshold,
the longitude of the ascending node 14 is defined as a function of the additional zone 2, such that it lies within an interval of values centred on the average longitude of the additional zone and having a length of 60°,
the two main satellites 4, 5 having a right ascension difference 15 of the ascending node 14 of 180° and with a true anomaly difference 15 of 180°; and

at least one earth station 15 configured to exchange data with at least one of said main satellites 4, 5.

FIG. 4 represents one of the two orbits 6 or 7 of one of the main satellites 4 or 5.

The right ascension 15 of the ascending node 14 is computed in relation to a reference 17 which is the average value of the longitudes of the additional zone 2, to best cover this additional zone 2.

The satellite system of the invention, which is non-geostationary, makes it possible to ensure the best permanent coverage over the zone 3 made up of a set of countries, or geographic locations called targets 2 and a polar cap 1.

The notion of “best coverage” is associated with a set of criteria to be ranked in order of importance depending on the mission (the services) envisaged. These criteria can comprise:

the permanency of observation (at least one of the satellites 4, 5 of the system is always visible from the targets, or else visible for a long period per day, for which an increase is sought);

the local elevation from which at least some of the points of a target 2 are observed; for example meteorological observation typically accepts only points observed from an elevation greater than approximately 20°; whereas a radio telecommunication service typically accepts elevations up to two times lower;

the observation distance (average for all of the points of a target, or for a given key point, or for the subsatellite plot), this also being able to be expressed in terms of “pixel size observed on the ground”;

the maximum extension of the additional zone 2 covered in the vicinity of a given target (for example, in meteorology or in Earth observation, a given country may want to observe a thousand kilometres beyond its borders);

the possible position of the reception and control ground station or stations 16, controlling the reception capacity in real time (“permanence”);

the capacity of the space launch vehicles to deploy the system; in particular the maximum weight that a given launch vehicle can place in final or transfer orbit constrains the size of the satellites that can be used, and, conversely, if the aim is to re-use an existing type of satellite, its weight constrains the extent of the possible orbits, by limiting for example the apogee 18 or the inclination 8;

the control of radiative environment conditions, with, for example, the objective of limiting the time of presence of the satellites 4, 5 in the Van Allen belts; and

the life span, through the cost of station-keeping in terms of consumables.

Pixel size should be understood to mean the surface on the ground represented by a pixel of the satellite image, or the average dimension of this surface.

The first threshold can be 90° when the additional zone has a minimum latitude lying between 10° and 30°, or 150° when the additional zone has a minimum latitude lying between 30° and 50°.

The inclination of the plane of the orbit in relation to the equatorial plane can lie between 60° and 65°, and for example be 63.5°, and the eccentricity of the orbit can be 0.25.

The argument 12 of the perigee 13 can lie between 280° and 290° for the coverage of a zone 1 of latitude above 55° combined with an additional zone 2 of latitudes below 55° and of longitudes lying within an interval of values having a length below the first threshold, or lie between 275° and 285° for the coverage of a zone 1 of latitude above 55° combined with an additional zone 2 of latitudes below 55° and of longitudes lying within an interval of values having a length below the first threshold, or lie between 280° and 300°, for the coverage of a zone 1 of latitude above 55° combined with an additional zone 2 of latitudes below 55° and of longitudes lying within an interval of values having a length below the first threshold.

The space system can comprise at least one additional satellite as redundant standby for a main satellite 4, 5, placed on the orbit of the corresponding main satellite, with a low anomaly offset between the additional satellite and the corresponding main satellite.

The space system can comprise at least one additional satellite placed on elliptical orbit around the Earth, distinct from the two orbits of the two main satellites but verifying the same characteristics, the deviation between two satellites of the system being such that their right ascension deviation of the ascending node and their true anomaly deviation are 360° divided by the number of main satellites of the orbital system.

A particular example consists in seeking a meteorological observation constellation covering the northern countries of Europe, but also incorporating another target country closer to the equator, so as to provide the service demanded, at the cost of a single system, to more investing countries.

The best solution is sought for:
a meteorological application with minimum elevation of 20°,
covering all the European arctic countries permanently,
also extending permanently over a geographic zone centred on the Middle East,
extending as far as possible also towards Canada, which is fully covered but possibly not permanently with an elevation above 20° for certain regions, and
finally observing the other constraints: launch possible for satellites similar to the existing geostationary system weather satellites, having a pixel size reasonably close to the usual performance in geostationary orbit, radiative environment close to that in geostationary orbit.

A typical starting point is chosen based on economic criteria: at the outset, it is considered that the satellite system has points in common with that used to cover only the zone of the northern countries, namely a minimum set of two satellites on two orbits, one known example of which is the 24 h Tundra orbit, as well as the “usual” geostationary observation systems.

An orbit over a 24 hour period is taken as the starting point. To ensure the coverage of the northernmost zones, the inclination is increased (and therefore two satellites are needed for continued permanence over the countries of interest).

To cover a pole permanently, it is necessary to switch to an elliptical orbit and favour one hemisphere, in this case the North Pole, and therefore take an apogee position of approximately 270°.

The orbital plane of a satellite is determined approximately such that it geometrically crosses all of the target countries, and is adjusted such that, during the passage of a satellite, the subsatellite point is located in or as close as possible to a target country. A subsatellite point should be understood to be the intersection between the surface of the Earth and the straight line linking the satellite to the centre of the Earth.

In this example, a longitude of the ascending node of 25° is determined, as illustrated in FIG. 6 where it is clearly illustrated that, during the movement of the satellite, the subsatellite point travels successively across the western Middle East up to the countries in the north of Europe, on the curve 20.

Finally, to minimize the apogee drifts over time, the inclination is maintained at the critical value of 63.5°, the conventional value on high earth orbits or “Highly Eccentric Orbits”, HEO.

The major half-axis can be adjusted to approximately 42,000 km and the eccentricity to 0.25 (24 h period), so as to prioritize a successive progression of the satellites in the regions of the apogee over the whole target zone and maximize the coverage of these zones.

The adjustment of the offset of the perigees/apogees is determined in such a way that the apogees are located in the regions of the barycentre of the target zones, which makes it possible to improve the coverage of Northern Europe, while retaining a good coverage of the country of interest.

The spacing of the two satellites of 180° in anomaly is obtained by verifying that the weights/volumes of typical weather satellites are compatible with typical Falcon 9 launches to these kinds of orbits.

In case of satellite redundancy, dual launches can be performed.

The intermediate transfer orbit is defined by the minimum allowing the satellite to continue by its own means.

On this last point, it is noteworthy that is then possible to use the typical circularization capacity provided in a satellite of geostationary type, so as to be able to re-use without modification an existing design (geostationary weather satellites) to define the possible transfer orbits.

In other words, in this option, the launch vehicles are required to have transfer orbit characteristics such that, with the geostationary circularization delta-V (typically 1500 m/s), it is possible to reach the previously defined final orbit, either by modifying the apogee and perigee altitudes, or by correcting the inclination of the orbital plane, or by combining these two actions.

The curve 20 of FIG. 6, in the form of a non-symmetrical deformed figure of 8, represents the plot of the satellite on the ground, that is to say all of the subsatellite points during one orbit. The orbits of the two main satellites 4, 5 are chosen such they have the same plot on the ground 20 in order to guarantee the permanency and repetitiveness of the coverage.

The level lines 21, 22, 23, 24, 25 et 26, 27, 28, 29, 30 respectively represent the minimum iso-elevation curves, that is to say the curves of the angle by which each of the satellites 4, 5 is seen from the ground. To provide products of a quality that is sufficient and that are able to be used by the end users, this elevation should always be greater than a nominal value, which depends on the service to be provided, typically of the order of 10° or more for telecommunications, or 20° or more for meteorological imaging (this value is for example estimated at at least 27° for the European meteorological services).

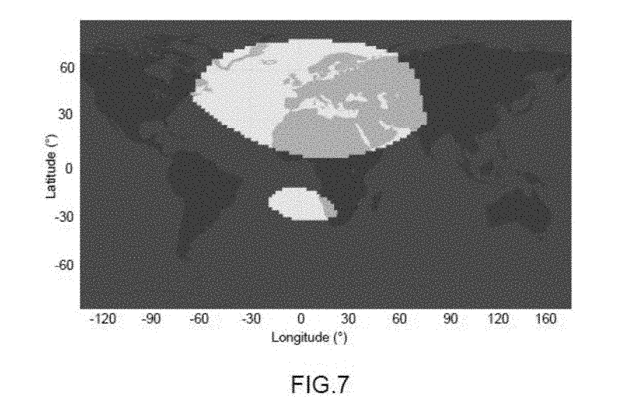

FIG. 7 schematically illustrates the terrestrial regions permanently covered by at least one of the satellites with a minimum elevation chosen to be 27°, according to one aspect of the invention.

1. A space system comprising:
two main satellites each describing a distinct elliptical orbit around the Earth, each of the two orbits verifying the following characteristics:
the inclination of the plane of the orbit in relation to the equatorial plane lies between 55° and 65°,
the eccentricity of the orbit lies between 0.2 and 0.3,
the major half-axis of the orbit is set so as to obtain a geosynchronous orbit,
the argument of the perigee lies between 240° and 265° or between 275° and 300° for the coverage of a zone of latitude above at least 55° combined with an additional zone of latitudes below at most 55° and of longitudes lying within an interval of values having a length below a first threshold; or lies between 60° and 85° or between 95° and 120° for the coverage of a zone of latitude below at most −55° combined with an additional zone of latitudes above at least −55° and of longitudes lying within an interval of values having a length below a second threshold,
the longitude of the ascending node is defined as a function of the additional zone, such that it lies within an interval of values centred on the average longitude of the additional zone and having a length less than 80°, and
the two main satellites having a right ascension difference of the ascending node of 180° and with a true anomaly difference of 180°; and
at least one earth station configured to exchange data with at least one of said main satellites.

2. The space system according to claim 1, wherein the first threshold is 90° when the additional zone has a minimum latitude lying between 10° and 30°.

3. The space station according to claim 1, wherein the first threshold is 150° when the additional zone has a minimum latitude lying between 30° and 50°.

4. The space system according to claim 1, wherein the second threshold is 90° when the additional zone has a minimum latitude lying between −30° and −10°.

5. The space system according to claim 1, wherein the second threshold is 150° when the additional zone has a minimum latitude lying between −50° and −30°.

6. The space system according to claim 1, wherein the inclination of the plane of the orbit in relation to the equatorial plane lies between 60° and 65°.

7. The space system according to claim 1, wherein the inclination of the plane of the orbit in relation to the equatorial plane is 63.5°.

8. The space system according to claim 1, wherein the eccentricity of the orbit is 0.25.

9. The space system according to claim 1, wherein the argument of the perigee lies between 280° and 290° for the coverage of a zone of latitude above 55° combined with an additional zone of latitudes below 55° and of longitudes lying within an interval of values having a length below the first threshold.

10. The space system according to claim 1, wherein the argument of the perigee lies between 275° and 285° for the coverage of a zone of latitude above 55° combined with an additional zone of latitudes below 55° and of longitudes lying within an interval of values having a length below the first threshold.

11. The space system according to claim 1, wherein the argument of the perigee lies between 280° and 300°, for the coverage of a zone of latitude above 55° combined with an additional zone of latitudes below 55° and of longitudes lying within an interval of values having a length below the first threshold.

12. The space system according to claim 1, comprising at least one additional satellite as redundant standby for a main satellite, placed on the orbit of the corresponding main satellite, with an anomaly offset between the additional satellite and the corresponding main satellite.

13. The space system according to claim 1, comprising at least one additional satellite placed on elliptical orbit around the Earth, distinct from the two orbits of the two main satellites but verifying said same characteristics, the deviation between two satellites of the system being such that their right ascension deviation of the ascending node and their true anomaly deviation are 360° divided by the number of main satellites of the orbital system.
